(19) United States
(12) Patent Application Publication
(10) Pub. No.: US 2017/0171491 A1
(43) Pub. Date: Jun. 15, 2017

(54) Method and Electronic Device for Adjusting Video Subtitles

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Yantong CHE, Beijing (CN)

(73) Assignees: LE HOLDINGS (BEIJING) CO., LTD., Beijing (CN); LE SHI INTERNET INFORMATION & TECHNOLOGY CORP., BEIJING, Beijing (CN)

(21) Appl. No.: 15/241,335

(22) Filed: Aug. 19, 2016

Related U.S. Application Data
(63) Continuation of application No. PCT/CN2016/088471, filed on Jul. 4, 2016.

(30) Foreign Application Priority Data
Dec. 11, 2015 (CN) 201510920471.9

(51) Int. Cl. H04N 5/445; G11B 27/036; H04N 21/485; H04N 7/088; H04N 21/488

(52) U.S. Cl. CPC H04N 5/44504; H04N 7/0882; H04N 21/4884; H04N 21/4858; G11B 27/036

(57) ABSTRACT

The embodiments of the present disclosure discloses a method and electronic device for adjusting video subtitles, which includes: first, obtaining a to-be-played video and subtitles corresponding to the video; obtaining subtitle adjusting parameters if the video is required to be played; adjusting a size of the subtitles corresponding to the video according to the subtitle adjusting parameters to obtain the subtitles corresponding to the subtitle adjusting parameters; and packaging the adjusted subtitles to the video and playing the video packaged with the subtitles. By solution disclosed in the disclosure, a terminal device can adjust, when a video is played, the size of the subtitles according to subtitle adjusting parameters, thereby being convenient for a user to watch.

### CROSS-REFERENCE TO RELATED APPLICATIONS

The disclosure is a continuation of International Application No. PCT/CN2016/088471, with an international filing date of Jul. 4, 2016, which claims priority to the Chinese Patent Application NO. 201510920471.9, entitled “METHOD AND DEVICE FOR ADJUSTING VIDEO SUBTITLES”, and filed with the Chinese Patent Office on Dec. 11, 2015, both of which are incorporated herein by reference in their entireties.

### TECHNICAL FIELD

The present disclosure relates to the technical field of terminal devices, and in particular, to a method and electronic device for adjusting video subtitles.

### BACKGROUND

With the development of technologies, various types of terminal devices appear in people's work and daily life. For example, a display screen may be combined with a treadmill so that a user can watch a video while using the treadmill; or a display screen is provided on a panel of a refrigerator so that the user can watch a video through the display screen while cooking.

However, in the research process of the present disclosure, the inventor finds that a size of subtitles displayed on the display screen is fixed when a video is played by the existing various types of terminal devices, which is inconvenient for the user to watch.

### SUMMARY

The present disclosure provides a method and electronic device for adjusting video subtitles, thereby solving, to some degree, the problem in traditional technique that the size of subtitles is fixed when a video is played, which is inconvenient for a user to watch.

In order to solve the above technical problem, embodiments of the present disclosure disclose the following technical solutions.

According to the first aspect of the embodiments of the present disclosure, a method for adjusting video subtitles is provided, the method includes:

Obtaining a to-be-played video and subtitles corresponding to the video;

Obtaining subtitle adjusting parameters if the video is required to be played;

Adjusting a size of the subtitles corresponding to the video according to the subtitle adjusting parameters to obtain the subtitles corresponding to the subtitle adjusting parameters; and

Packaging the adjusted subtitles to the video and playing the video packaged with the subtitles.

According to the second aspect of the embodiments of the present disclosure, the embodiment of the present disclosure provides a non-volatile computer-readable storage medium stored with computer executable instructions, the computer executable instructions are configured to perform any one of the method for adjusting video subtitles described above in the disclosure.

According to the third aspect of the embodiments of the present disclosure, the embodiment of the present disclosure provides an electronic device, comprising: at least one processor; and a memory; wherein, the memory is communicably connected with the at least one processor for storing instructions executed by the at least one processor, the computer executable instructions are configured to perform any one of the method for adjusting video subtitles described above in the disclosure.

The embodiments of the present disclosure has the following advantageous effects.

By solutions disclosed in the embodiments of the present disclosure, a terminal device can adjust, when a video is played, the size of subtitles according to subtitle adjusting parameters, thereby being convenient for the user to watch.

It should be understood that the general description above and detailed description below are merely exemplary and illustrative, and cannot limit the present disclosure.

### BRIEF DESCRIPTION OF THE DRAWINGS

One or more embodiments are illustrated by way of examples, and not by limitation, in the figures of the accompanying drawings, wherein elements having the same reference numeral designations represent like elements throughout. The drawings are not to scale, unless otherwise disclosed.

FIG. 1 is a schematic flow chart of a method for adjusting video subtitles disclosed by an embodiment of the present disclosure;

FIG. 2 (a) is a schematic diagram of display screen showing a video before packaging in a method for adjusting video subtitles disclosed by an embodiment of the present disclosure;

FIG. 2 (b) is a schematic diagram of display screen showing a video after packaging in a method for adjusting video subtitles disclosed by an embodiment of the present disclosure;

FIG. 3 is a schematic diagram of structure of a device for adjusting video subtitles disclosed by an embodiment of the present disclosure;

FIG. 4 is a schematic diagram of structure of an electronic device provided by an embodiment of the present disclosure.

### DETAILED DESCRIPTION

Embodiments of the present disclosure provide a method and device for adjusting video subtitles, thereby solving, to some extent, the problem in traditional technique that the size of subtitles is fixed when a video is played, which is inconvenient for the user to watch.

In order to make those skilled in the art understand technical solutions of the embodiments of the present disclosure better, and in order to make the above objects, features and advantages of the embodiments of the present disclosure more apparent and understandability, the technical solutions in the embodiments of the present disclosure will be further described in details below in conjunction with the figures.

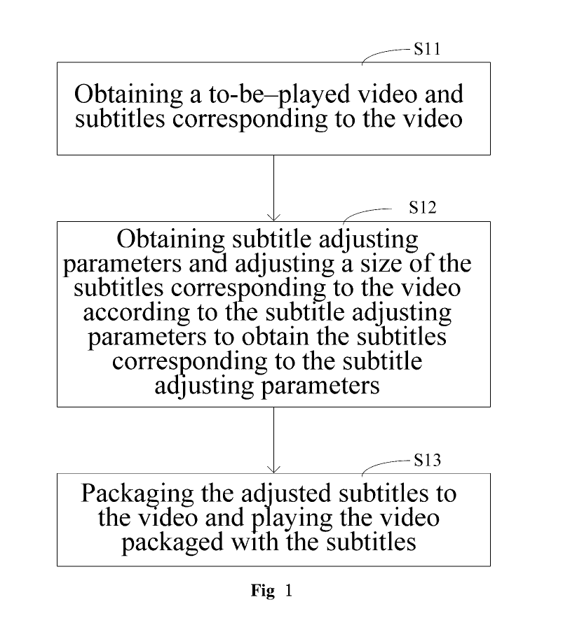

In the first embodiment of the present disclosure, a method for adjusting video subtitles is disclosed. Referring to the work flow chart shown in FIG. 1, the method for adjusting video subtitles includes the following steps.

Step S11: a to-be-played video is obtained and subtitles corresponding to the video are obtained.

Wherein, a plurality of methods may be employed when the subtitles corresponding to the video are obtained. In one method thereof, external subtitles of the video may be obtained as the subtitles corresponding to the video by an access to server. Besides, if the to-be-played video includes embedded subtitles, the embedded subtitles of the video may be obtained as the subtitles corresponding to the video.

If the to-be-played video includes the embedded subtitles, the embedded subtitles of the video may be obtained by way of clipping. The embedded subtitles in the video are generally located close to edges of the video, instead of at the center of the video. Therefore, in the case of not affecting the appreciation of the picture, the subtitles located close to edges of the video may be clipped to obtain the embedded subtitles of the video. Moreover, the video may be segmented further to obtain each frame image corresponding to the video, and the subtitles included in each frame image are extracted by image processing techniques to obtain the embedded subtitles of the video.

Step S12: subtitle adjusting parameters are obtained if the video is required to be played, and a size of the subtitles corresponding to the video is adjusted according to the subtitle adjusting parameters to obtain the subtitles corresponding to the subtitle adjusting parameters.

In an embodiment of the present disclosure, the subtitle adjusting parameters generally include: running states of a terminal device, and/or, a distance between a display screen of the terminal device and a user. Certainly, other forms of the subtitle adjusting parameters may also be employed. The embodiment of the present disclosure makes no limit hereto.

The terminal device which is suitable for the method for adjusting video subtitles disclosed by an embodiment of the present disclosure includes multiple types. Thus, the subtitle adjusting parameters used are different. For example, if the terminal device is a treadmill provided with a display screen, the subtitle adjusting parameters are generally the running states of the terminal device and the distance between the display screen of the terminal device and the user. Wherein, the running states of the terminal device are generally stationary, walking and running states. Generally, the subtitle size required by the user in running state is greater than the subtitle size displayed in walking state. Generally, the faster speed of running, the larger subtitle size the user requires. Further, the farther distance between the display screen of the terminal device and the user, the larger size of the adjusted subtitles is, so that the user can watch the subtitles clearly during exercise.

In addition, if the terminal device is a refrigerator provided with a display screen, in this case, the subtitle adjusting parameters are generally a distance between the display screen of the terminal device and a user. The farther the distance between the display screen and the user, the larger size of the adjusted subtitles is, so that the user can watch the subtitles clearly.

Step S13: the adjusted subtitles are packaged to the video and the video packaged with the subtitles is played.

The first embodiment of the present disclosure discloses a method for adjusting video subtitles. In this method, a to-be-played video and the subtitles corresponding to the video are obtained; subtitle adjusting parameters are obtained if the video is required to be played; a size of the subtitles corresponding to the video is adjusted according to the subtitle adjusting parameters to obtain the subtitles corresponding to the subtitle adjusting parameters; and adjusted subtitles are packaged to the video and the video packaged with the subtitles is played.

By the method disclosed by the embodiment of the present disclosure, a terminal device can adjust, when a video is played, the size of the subtitles according to the subtitle adjusting parameters, thereby being convenient for the user to watch.

Further, the method for adjusting video subtitles disclosed by the embodiment of the present disclosure also includes:

Presetting correspondence between the various subtitle adjusting parameters and the size of the subtitles, and storing the correspondence, so as to adjust the size of the subtitles according to the correspondence after the subtitle adjusting parameters are obtained.

In the embodiment of the disclosure, correspondence between the various subtitle adjusting parameters and the size of the subtitles is prestored, in this case, the subtitle size required may be determined according to the correspondence after the subtitle adjusting parameters are obtained, and then the size of the subtitles is adjusted as required.

If the subtitle adjusting parameters include a distance between a display screen of the terminal device and a user, the distance between the display screen of the terminal device and the user is obtained by a distance sensor preset in the terminal device, in the method for adjusting video subtitles disclosed by the embodiment of the present disclosure.

Wherein, the distance sensor preset in the terminal device may be in many forms, such as an infrared distance measuring sensor, and etc. The embodiment of the present disclosure makes no limit hereto.

Moreover, in Step S13 of the embodiment of the present disclosure, a technical feature for packaging the adjusted subtitles to the video is disclosed. If the video does not include embedded subtitles before packaging, packaging the adjusted subtitles to the video includes:

First, segmenting the video to obtain each frame image that forms the video; and loading the adjusted subtitles at a preset location of the each frame image.

Wherein, a subtitles embedding technique is generally used when the adjusted subtitles are loaded at the preset location of each frame image.

Besides, if the video includes embedded subtitles before packaging, packaging the adjusted subtitles to the video includes:

First, segmenting the video to obtain each frame image that forms the video; and then loading a shielding background at a location of the embedded subtitles, so as to shield the embedded subtitles by the shielding background; and at last, loading the adjusted subtitles at a location of the shielding background.

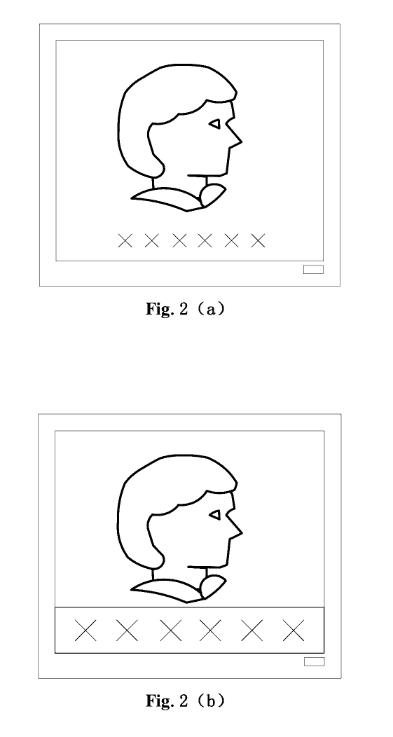

Referring to the schematic diagram of a display screen as shown in FIG. 2 (a), the video displayed on the display screen is a video before packaging, and the embedded subtitles are provided under the video; in solutions of the embodiment of the present disclosure, in order to avoid interference between the adjusted subtitles and the embedded subtitles during the adjusted subtitles are packaged, a shielding background is provided to shield the embedded subtitles, and the adjusted subtitles are loaded at the location of the shielding background, wherein, after subtitle loading has finished, the video displayed on the display screen is shown as in FIG. 2 (b). The embedded subtitles of the video are shielded by the shielding background to avoid the interference to the adjusted subtitles.

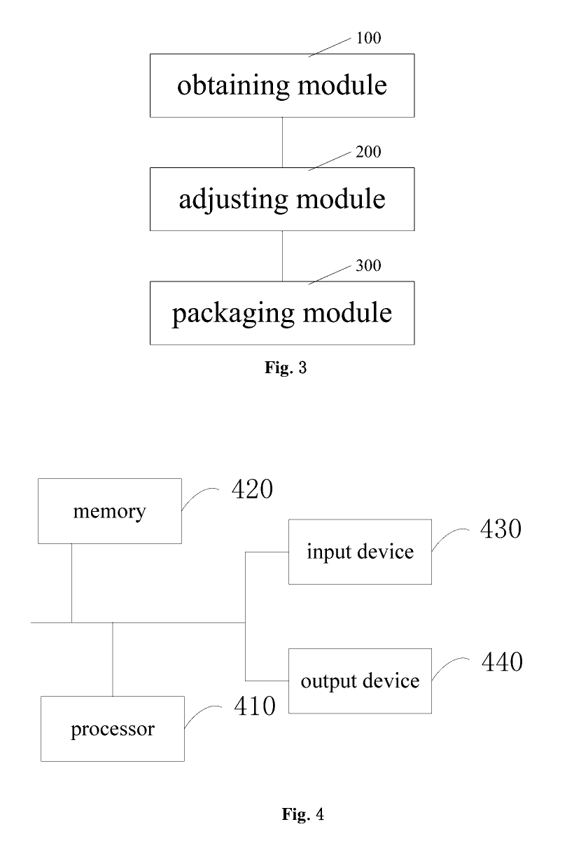

Correspondingly, the second embodiment of the present disclosure discloses a device for adjusting video subtitles, referring to the structure schematic diagram shown in FIG. 3, the device includes: an obtaining module 100, an adjusting module 200 and a packaging module 300.

Wherein, the obtaining module 100 is configured to obtain a to-be-played video and obtain subtitles corresponding to the video;

the adjusting module 200 is configured to obtain subtitle adjusting parameters if the video is required to be played, and adjust a size of the subtitles corresponding to the video according to the subtitle adjusting parameters to obtain the subtitles corresponding to the subtitle adjusting parameters; and

The packaging module 300 is configured to package adjusted subtitles to the video and play the video packaged with the subtitles.

The second embodiment of the present disclosure discloses a device for adjusting video subtitles. In the device, a to-be-played video and the subtitles corresponding to the video are obtained by the obtaining module; subtitle adjusting parameters are obtained by the adjusting module if the video is required to be played, and a size of the subtitles corresponding to the video is adjusted according to the subtitle adjusting parameters to obtain the subtitles corresponding to the subtitle adjusting parameters; and adjusted subtitles are packaged to the video by the packaging module and the video packaged with the subtitles is played.

By the device disclosed in the embodiment of the present disclosure, the terminal device can adjust the size of the subtitles, when a video is played, thereby being convenient for the user to watch.

Further, the device for adjusting video subtitles disclosed by the embodiment of the disclosure also includes a prestoring module.

The prestoring module is configured to preset correspondence between the various subtitle adjusting parameters and the size of the subtitles and store the correspondence, so as to adjust the size of the subtitles according to the correspondence after the subtitle adjusting parameters are obtained.

In the embodiment of the disclosure, the correspondence between the various subtitle adjusting parameters and the size of the subtitles is prestored by the prestoring module, in this case, the subtitle size required may be determined according to the correspondence by the adjusting module after the subtitle adjusting parameters are obtained, and the size of the subtitles is adjusted as required.

In the embodiment of the present disclosure, the subtitle adjusting parameters include: running states of a terminal device, and/or, a distance between a display screen of the terminal device and a user. Certainly, other forms of the subtitle adjusting parameters may also be used. The embodiment of present disclosure makes no limit hereto.

Further, if the subtitle adjusting parameters include the distance between the display screen of the terminal device and the user, the obtaining module obtains the distance between the display screen of the terminal device and the user by a distance sensor preset in the terminal device

Wherein, the distance sensor preset in the terminal device may be in many forms, such as an infrared distance measuring sensor, and etc. The present disclosure makes no limit hereto.

Further, if the video does not include embedded subtitles before packaging, the packaging module includes:

A first segmenting unit configured to segment the video to obtain each frame image that forms the video; and

A first loading unit configured to load the adjusted subtitles at a preset location of the each frame image.

Further, if the video includes embedded subtitles before packaging, the packaging module includes:

A second segmenting unit configured to segment the video to obtain each frame image that forms the video;

A background setting unit configured to load a shielding background at a location of the embedded subtitles so as to shield the embedded subtitles by the shielding background; and

A second loading unit configured to load the adjusted subtitles at a location of the shielding background.

If the video includes embedded subtitles before packaging, in order to avoid interference between the embedded subtitles and the adjusted subtitles during the adjusted subtitles are packaged, a shielding background is loaded by the background setting unit so as to shield the embedded subtitles, and the adjusted subtitles are loaded at a location of the shielding background.

With respect to the device in the above embodiments, the detailed implementations in which each module performs operations have been described in details in the embodiments with related to the methods, and detailed description will be omitted herein.

Embodiments of the present disclosure further provide a non-volatile computer-readable storage medium, the non-volatile computer-readable storage medium is stored with computer executable instructions which are configured to perform any of the embodiments described above of the method for adjusting video subtitles.

FIG. 4 is a schematic diagram of hardware structure of an electronic device used to perform the method for adjusting video subtitles according to an embodiment of the present disclosure, as shown in FIG. 4, the device includes:

One or more processors 410 and a memory 420, FIG. 4 illustrates one processor 410 as an example.

The device for the method for adjusting video subtitles may further include an input device 430 and an output device 440.

The processor 410, the memory 420, the input device 430 and the output device 440 may be connected with each other through bus or other forms of connections. FIG. 4 illustrates bus connection as an example.

As a non-volatile computer-readable storage medium, the memory 420 may be configured to store non-volatile software program, non-volatile computer executable program and modules, such as program instructions/modules corresponding to the method for adjusting video subtitles according to the embodiments of the disclosure (for example, the obtaining module 100, the adjusting module 200 and the packaging module 300, as illustrated in FIG. 3. By executing the non-volatile software program, instructions and modules stored in the memory 420, the processor 410 may perform various functional applications of the server and data processing, that is, the method for adjusting video subtitles according to the above mentioned embodiments.

The memory 420 may include a program storage area and a data storage area, wherein, the program storage area may be stored with the operating system and applications which are needed by at least one functions, and the data storage area may be stored with data which is created according to use of the device for adjusting video subtitles. Further, the memory 420 may include a high-speed random access memory, and may further include non-volatile memory, such as at least one of disk memory device, flash memory device or other types of non-volatile solid state memory device. In some embodiments, optionally, the memory 420 may include memory provided remotely from the processor 410, and such remote memory may be connected with the device for adjusting video subtitles through network connections, the examples of the network connections may include but not limited to internet, intranet, LAN (Local Area Network), mobile communication network or combinations thereof.

The input device 430 may receive inputted number or character information, and generate key signal input related to the user settings and functional control of the device for adjusting video subtitles. The output device 440 may include a display device such as a display screen.

The above one or more modules may be stored in the memory 420, when these modules are executed by the one or more processors 410, the method for adjusting video subtitles according to any one of the above mentioned method embodiments may be performed.

The above product may perform the methods provided in the embodiments of the disclosure, include functional modules corresponding to these methods and advantageous effects. Further technical details which are not described in detail in the present embodiment may refer to the method provided according to embodiments of the disclosure.

The electronic device in the embodiment of the present disclosure exists in various forms, including but not limited to:

(1) mobile communication device, characterized in having a function of mobile communication mainly aimed at providing speech and data communication, wherein such terminal includes: smart phone (such as iPhone), multimedia phone, functional phone, low end phone and the like;

(2) ultra mobile personal computer device, which falls in a scope of personal computer, has functions of calculation and processing, and generally has characteristics of mobile internet access, wherein such terminal includes: PDA, MID and UMPC devices, such as iPad;

(3) portable entertainment device, which can display and play multimedia contents, and includes audio or video player (such as iPod), portable game console, E-book and smart toys and portable vehicle navigation device;

(4) server, an device for providing computing service, constituted by processor, hard disc, internal memory, system bus, and the like, which has a framework similar to that of a computer, but is demanded for superior processing ability, stability, reliability, security, extendibility and manageability due to that high reliable services are desired; and

(5) other electronic devices having a function of data interaction.

The above mentioned examples for the device are merely exemplary, wherein the unit illustrated as a separated component may be or may not be physically separated, the component illustrated as a unit may be or may not be a physical unit, in other words, may be either disposed in some place or distributed to a plurality of network units. All or part of modules may be selected as actually required to realize the objects of the present disclosure. Such selection may be understood and implemented by ordinary skill in the art without creative work.

According to the description in connection with the above embodiments, it can be clearly understood by ordinary skill in the art that various embodiments can be realized by means of software in combination with necessary universal hardware platform, and certainly, may further be realized by means of hardware. Based on such understanding, the above technical solutions in substance or the part thereof that makes a contribution to the prior art may be embodied in a form of a software product which can be stored in a computer-readable storage medium, such as ROM/RAM, magnetic disk and compact disc, and includes several instructions for allowing a computer device (which may be a personal computer, a server, a network device or the like) to execute the methods described in various embodiments or some parts thereof.

Finally, it should be stated that, the above embodiments are merely used for illustrating the technical solutions of the present disclosure, rather than limiting them. Although the present disclosure has been illustrated in details in reference to the above embodiments, it should be understood by ordinary skill in the art that some modifications can be made to the technical solutions of the above embodiments, or part of technical features can be substituted with equivalents thereof. Such modifications and substitutions do not cause the corresponding technical features to depart in substance from the spirit and scope of the technical solutions of various embodiments of the present disclosure.

What is claimed is:

1. A method for adjusting video subtitles, comprising:
at an electronic device:
obtaining a to-be-played video and subtitles corresponding to the video;
obtaining subtitle adjusting parameters if the video is required to be played;
adjusting a size of the subtitles corresponding to the video according to the subtitle adjusting parameters to obtain the subtitles corresponding to the subtitle adjusting parameters; and
packaging the adjusted subtitles to the video and playing the video packaged with the subtitles.

2. The method according to claim 1, further comprising:
presetting correspondence between various subtitle adjusting parameters and the size of the subtitles and storing the correspondence, so as to adjust the size of the subtitles according to the correspondence after the subtitle adjusting parameters are obtained.

3. The method according to claim 1, wherein, the subtitle adjusting parameters comprise:
running states of a terminal device, and/or, a distance between a display screen of the terminal device and a user.

4. The method according to claim 1, further comprising:
obtaining the distance between the display screen of the terminal device and the user by a distance sensor preset in the terminal device, if the subtitle adjusting parameters comprise the distance between the display screen of the terminal device and the user.

5. The method according to claim 1, wherein, if the video does not comprise embedded subtitles before packaging, packaging the adjusted subtitles to the video comprises:
segmenting the video to obtain each frame image that forms the video; and
loading the adjusted subtitles at a preset location of the each frame image.

6. The method according to claim 1, wherein, if the video comprises embedded subtitles before packaging, the packaging the adjusted subtitles to the video comprises:
segmenting the video to obtain each frame image that forms the video;
loading a shielding background at a location of the embedded subtitles so as to shield the embedded subtitles by the shielding background; and
loading the adjusted subtitles at a location of the shielding background.

7. A non-volatile computer-readable storage medium stored with computer executable instructions that, when executed by an electronic device, cause the electronic device to:
obtain a to-be-played video and subtitles corresponding to the video;
obtain subtitle adjusting parameters if the video is required to be played;
adjust a size of the subtitles corresponding to the video according to the subtitle adjusting parameters to obtain the subtitles corresponding to the subtitle adjusting parameters; and
package the adjusted subtitles to the video and play the video packaged with the subtitles.

8. The non-volatile computer-readable storage medium according to claim 7, wherein, the electronic device is further caused to:
preset correspondence between various subtitle adjusting parameters and the size of the subtitles and store the correspondence, so as to adjust the size of the subtitles according to the correspondence after the subtitle adjusting parameters are obtained.

9. The non-volatile computer-readable storage medium according to claim 7, wherein,
the subtitle adjusting parameters comprise: running states of a terminal device, and/or, a distance between a display screen of the terminal device and a user.

10. The non-volatile computer-readable storage medium according to claim 7, wherein, the electronic device is further caused to:
obtain the distance between the display screen of the terminal device and the user by a distance sensor preset in the terminal device, if the subtitle adjusting parameters comprise the distance between the display screen of the terminal device and the user.

11. The non-volatile computer-readable storage medium according to claim 7, wherein, if the video does not comprise embedded subtitles before packaging, the packaging the adjusted subtitles to the video comprises:
segmenting the video to obtain each frame image that forms the video; and
loading the adjusted subtitles at a preset location of the each frame image.

12. The non-volatile computer-readable storage medium according to claim 7, wherein, if the video comprises embedded subtitles before packaging, the packaging the adjusted subtitles to the video comprises:
segmenting the video to obtain each frame image that forms the video;
loading a shielding background at a location of the embedded subtitles so as to shield the embedded subtitles by the shielding background; and
loading the adjusted subtitles at a location of the shielding background.

13. An electronic device, comprising:
at least one processor; and
a memory, communicably connected with the at least one processor for storing instructions executed by the at least one processor,
wherein the execution of the instructions by the at least one processor causes the at least one processor to:
obtain a to-be-played video and subtitles corresponding to the video;
obtain subtitle adjusting parameters if the video is required to be played;
adjust a size of the subtitles corresponding to the video according to the subtitle adjusting parameters to obtain the subtitles corresponding to the subtitle adjusting parameters; and
package the adjusted subtitles to the video and play the video packaged with the subtitles.

14. The electronic device according to claim 13, wherein, the at least one processor is further caused to:
preset correspondence between various subtitle adjusting parameters and the size of the subtitles and store the correspondence, so as to adjust the size of the subtitles according to the correspondence after the subtitle adjusting parameters are obtained.

15. The electronic device according to claim 13, wherein, the subtitle adjusting parameters comprise:
running states of a terminal device, and/or, a distance between a display screen of the terminal device and a user.

16. The electronic device according to claim 13, wherein, the at least one processor is further caused to:
obtain the distance between the display screen of the terminal device and the user by a distance sensor preset in the terminal device, if the subtitle adjusting parameters comprise the distance between the display screen of the terminal device and the user.

17. The electronic device according to claim 13, wherein, if the video does not comprise embedded subtitles before packaging, the packaging the adjusted subtitles to the video comprises:
segmenting the video to obtain each frame image that forms the video; and
loading the adjusted subtitles at a preset location of the each frame image.

18. The electronic device according to claim 13, wherein, if the video comprises embedded subtitles before packaging, the packaging the adjusted subtitles to the video comprises:
segmenting the video to obtain each frame image that forms the video;
loading a shielding background at a location of the embedded subtitles so as to shield the embedded subtitles by the shielding background; and
loading the adjusted subtitles at a location of the shielding background.
